(19) United States
(12) Patent Application Publication
(10) Pub. No.: US 2009/0245655 A1
(43) Pub. Date: Oct. 1, 2009

(54) Detection of Face Area and Organ Area in Image

(75) Inventor: Kenji MATSUZAKA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/405,030

(22) Filed: Mar. 16, 2009

(30) Foreign Application Priority Data
Mar. 25, 2008 (JP) 2008-079246

(51) Int. Cl. G06K 9/46

(52) U.S. Cl. 382/203

(57) ABSTRACT

An image processing apparatus includes: a face area detecting unit detects a face area corresponding to a face image in a target image; an image generating unit that generates an organ detecting image including the face image which is inclined in a predetermined angular range in an image plane on the basis of the detection result of the face area; and an organ area detecting unit that detects an organ area corresponding to a facial organ image in the face area on the basis of image data indicating the organ detecting image.

### BACKGROUND

1. Technical Field

The present invention relates to a technique for detecting a face area and an organ area in an image.

2. Related Art

A technique has been proposed which detects a face area corresponding to a face image from an image and detects an organ area corresponding to an image of a facial organ (for example, an eye) from the face area (for example, JP-A-2006-065640 and JP-A-2006-179030).

When the organ area is detected from the face area, it is preferable to improve the accuracy of a detecting process or increase the speed of the detecting process.

### SUMMARY

An advantage of some aspects of the invention is that it provides a technique capable of improving the accuracy of a process of detecting an organ area from a face area and increasing the speed of the detecting process.

According to a first aspect of the invention, an image processing apparatus includes: a face area detecting unit detects a face area corresponding to a face image in a target image; an image generating unit that generates an organ detecting image including the face image which is inclined in a predetermined angular range in an image plane on the basis of the detection result of the face area; and an organ area detecting unit that detects an organ area corresponding to a facial organ image in the face area on the basis of image data indicating the organ detecting image.

In the image processing apparatus having the above-mentioned structure, a face area corresponding to a face image in a target image is detected, an organ detecting image including the face image which is inclined in a predetermined angular range in an image plane is generated on the basis of the detection result of the face area, and an organ area corresponding to a facial organ image in the face area is detected on the basis of image data indicating the organ detecting image. Therefore, it is possible to improve the accuracy of a process of detecting the organ area from the face area and increase the speed of the detecting process.

According to a second aspect of the invention, in the image processing apparatus according to the first aspect, the image generating unit may set a specific image area including the face area on the basis of the face area, and adjust the inclination of the specific image area to generate the organ detecting image.

In the image processing apparatus having the above-mentioned structure, a specific image area including the face area is set on the basis of the face area, and the inclination of the specific image area is adjusted to generate the organ detecting image. Therefore, it is possible to generate an organ detecting image including a face image that is inclined in a predetermined angular range in an image plane.

According to a third aspect of the invention, in the image processing apparatus according to the second aspect, the face area detecting unit may include: a determination target setting unit that sets a determination target image area in an image area on the target image; a storage unit that stores a plurality of evaluating data which are associated with different inclination values and are used to calculate an evaluated value indicating that the determination target image area is certainly an image area corresponding to a face image having an inclination value in a predetermine range including the inclination value associated with the evaluating data; an evaluated value calculating unit that calculates the evaluated value on the basis of the evaluating data and image data corresponding to the determination target image area; and an area setting unit that sets the face area on the basis of the evaluated value, and the position and the size of the determination target image area. The image generating unit may set an adjustment amount for adjusting the inclination of the specific image area, on the basis of the inclination value associated with the evaluating data used to detect the face area.

In the image processing apparatus having the above-mentioned structure, an adjustment amount for adjusting the inclination of the specific image area is set on the basis of the inclination value associated with the evaluating data used to detect the face area. Therefore, it is possible to generate an organ detecting image including a face image that is inclined in a predetermined angular range in an image plane.

According to a fourth aspect of the invention, in the image processing apparatus according to the third aspect, the area setting unit may determine whether the determination target image area is an image area corresponding to the face image having an inclination value in a predetermine range including the inclination value associated with the evaluating data, on the basis of the evaluated value. When it is determined that the determination target image area is an image area corresponding to the face image having an inclination value in a predetermine range including the inclination value associated with the evaluating data, the area setting unit may set the face area on the basis of the position and the size of the determination target image area.

According to a fifth aspect of the invention, in the image processing apparatus according to any one of the second to fourth aspects, the image generating unit may adjust the resolution of the specific image area such that the organ detecting image has a predetermined size, thereby generating the organ detecting image.

In the image processing apparatus having the above-mentioned structure, the resolution of the specific image area is adjusted such that the organ detecting image has a predetermined size, thereby generating the organ detecting image. Therefore, it is possible to further improve the accuracy of a process of detecting an organ area from a face area and increase the speed of the detecting process.

According to a sixth aspect of the invention, in the image processing apparatus according to any one of the second to fifth aspects, the image generating unit may set, as the specific image area, an image area that is defined by a frame obtained by enlarging an edge frame of the face area in the target image.

In the image processing apparatus having the above-mentioned structure, an image area that is defined by a frame obtained by enlarging an edge frame of the face area in the target image is set as the specific image area. Therefore, it is possible to further improve the accuracy of a process of detecting an organ area from a face area and increase the speed of the detecting process.

According to a seventh aspect of the invention, in the image processing apparatus according to any one of the first to sixth aspects, the kinds of facial organs may include at least one of a right eye, a left eye, and a mouth.

In the image processing apparatus having the above-mentioned structure, it is possible to improve the accuracy of a process of detecting an organ area corresponding to at least one of the right eye, the left eye, and the mouth from the face area and increase the speed of the detecting process.

The invention can be achieved by various aspects. For example, the invention can be achieved in the forms of an image processing method and apparatus, an organ area detecting method and apparatus, a computer program for executing the functions of the apparatuses or the methods, a recording medium having the computer program recorded thereon, and data signals that include the computer program and are transmitted as carrier waves.

### BRIEF DESCRIPTION OF THE DRAWINGS

The invention will be described with reference to the accompanying drawings, wherein like numbers reference like elements.

FIG. 1 is a diagram schematically illustrating the structure of a printer 100, which is an image processing apparatus according to an embodiment of the invention.

FIGS. 2A to 2F are diagrams illustrating the types of face learning data FLD and facial organ learning data OLD.

FIG. 3 is a flowchart illustrating the flow of image processing.

FIG. 4 is a diagram illustrating an example of a user interface for setting the type of image processing.

FIG. 5 is a flowchart illustrating the flow of a face area detecting process.

FIG. 6 is a diagram illustrating the outline of the face area detecting process.

FIG. 7 is a diagram illustrating the outline of a method of calculating a cumulative evaluated value Tv used for face determination.

FIG. 8 is a diagram illustrating an example of sample images used for learning for setting the face learning data FLD corresponding to a face in the front direction.

FIGS. 9A and 9B are diagrams illustrating the outline of a face area setting process.

FIGS. 10A to 10C are diagrams illustrating the outline of the face area setting process.

FIG. 11 is a flowchart illustrating the flow of an organ area detecting process.

FIG. 12 is a diagram illustrating the outline of the organ area detecting process.

FIG. 13 is a diagram illustrating an example of the content of a size table ST.

### DESCRIPTION OF EXEMPLARY EMBODIMENTS

Hereinafter, exemplary embodiments of the invention will be described in the following order:

A. Embodiments;

A-1. Structure of image processing apparatus;

A-2. Image processing; and

B. Modifications.

### A. Embodiments

### A-1. Structure of Image Processing Apparatus

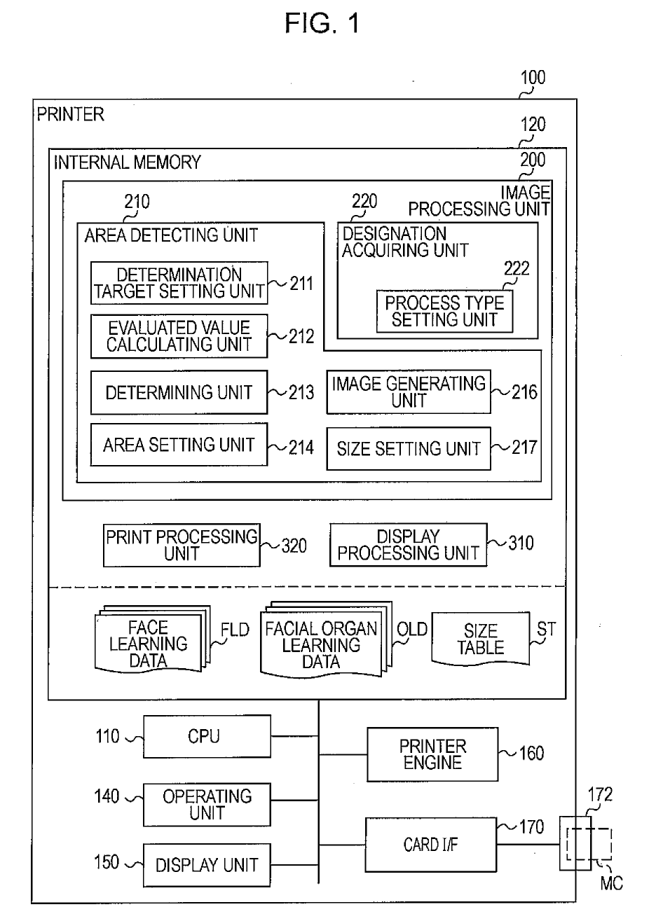

FIG. 1 is a diagram schematically illustrating the structure of a printer 100, which is an image processing apparatus according to an embodiment of the invention. The printer 100 according to this embodiment is an ink jet color printer corresponding to so-called direct printing that performs printing on the basis of image data obtained from a memory card MC. The printer 100 includes a CPU 110 that controls all components of the printer 100, an internal memory 120 that is composed of a ROM or a RAM, an operating unit 140 that includes buttons or a touch panel, a display unit 150 that is composed of a liquid crystal display, a printer engine 160, and a card interface (card I/F) 170. The printer 100 may further include interfaces for data communication with other apparatuses (for example, a digital still camera or a personal computer). The components of the printer 100 are connected to one another by a bus.

The printer engine 160 is a printing mechanism that performs printing on the basis of print data. The card interface 170 is for data communication with the memory card MC inserted into the card slot 172. In this embodiment, image files including image data are stored in the memory card MC.

The internal memory 120 includes an image processing unit 200, a display processing unit 310, and a print processing unit 320. The image processing unit 200 is a computer program that performs image processing, which will be described below, under the control of a predetermined operating system. The display processing unit 310 is a display driver that controls the display unit 150 to display, for example, a process menu, a message, or an image. The print processing unit 320 is a computer program that generates print data from image data and controls the printer engine 160 to print images on the basis of the print data. The CPU 110 reads these programs from the internal memory 120 and executes the read programs to implement the functions of the above-mentioned units.

The image processing unit 200 includes an area detecting unit 210 and a process type setting unit 220 as program modules. The area detecting unit 210 detects an image area corresponding to a predetermined type of subject image (a face image and a facial organ image) from a target image indicated by target image data. The area detecting unit 210 includes a determination target setting unit 211, an evaluated value calculating unit 212, a determining unit 213, an area setting unit 214, an image generating unit 216, and a size setting unit 217. The functions of these units will be described in detail when image processing is described. The area detecting unit 210 serves as a face area detecting unit and an organ area detecting unit according to the invention in order to detect a face area corresponding to a face image and an organ area corresponding to a facial organ image, which will be described. In addition, the determining unit 213 and the area setting unit 214 serve as an area setting unit according to the invention.

The process type setting unit 220 sets the type of image processing to be performed. The process type setting unit 220 includes a designation acquiring unit 222 that acquires the type of image processing to be performed which is designated by a user.

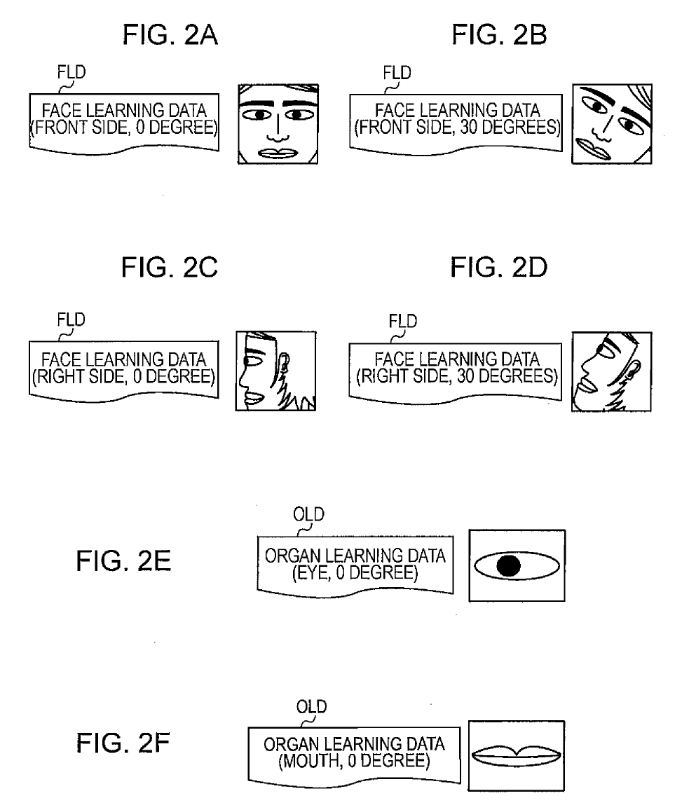

The internal memory 120 stores a plurality of predetermined face learning data FLD and a plurality of predetermined facial organ learning data OLD. The face learning data FLD and the facial organ learning data OLD are used for the area detecting unit 210 to detect a predetermined image area. FIGS. 2A to 2F are diagrams illustrating the kinds of face learning data FLD and facial organ learning data OLD. FIGS. 2A to 2F show the kinds of face learning data FLD and facial organ learning data OLD and examples of the image areas detected by these kinds of face learning data FLD and facial organ learning data OLD.

The content of the face learning data FLD will be described in detail in the following description of image processing. The face learning data FLD is set so as to be associated with a combination of face inclination and face direction. The face inclination means the inclination (rotation angle) of a face in an image plane. That is, the face inclination is the rotation angle of a face on an axis that is vertical to the image plane. In this embodiment, when the state in which the upper direction of an area or a subject is aligned with the upper direction of the target image is referred to as a reference state (inclination=0 degree), the inclination of the area or the subject on the target image is represented by a rotation angle from the reference state in the clockwise direction. For example, when the state in which a face is disposed along the vertical direction of a target image (the top of the head faces upward and the jaw faces downward) is referred to as a reference state (face inclination=0 degree), the face inclination is represented by the rotation angle of a face from the reference state in the clockwise direction.

The face direction means the direction of a face out of an image plane (the angle of the aspect of a face). The aspect of a face means the direction of a face with respect to the axis of a substantially cylindrical head. That is, the face direction is the rotation angle of a face on an axis that is parallel to the image plane. In this embodiment, a ‘front direction’ means that a face looks directly at an imaging surface of an image generating apparatus, such as a digital still camera, a ‘right direction’ means that a face turns to the right side of the imaging surface (the image of a face that turns to the left side when a viewer views the image), and a ‘left direction’ means that a face turns to the left side of the imaging surface (the image of a face that turns to the right side when a viewer views the image).

The internal memory 120 stores four face learning data FLD shown in FIGS. 2A to 2D, that is, face learning data FLD corresponding to a combination of a face in the front direction and a face inclination of 0 degree shown in FIG. 2A, face learning data FLD corresponding to a combination of a face in the front direction and a face inclination of 30 degrees shown in FIG. 2B, face learning data FLD corresponding to a combination of a face in the right direction and a face inclination of 0 degree shown in FIG. 2C, and face learning data FLD corresponding to a combination of a face in the right direction and a face inclination of 30 degrees shown in FIG. 2D. The face in the front direction and the face in the right direction (or in the left direction) may be analyzed as different kinds of subjects. In this case, the faces may be represented by combinations of face learning data FLD, the type of subject, and the inclination of the subject.

Face learning data FLD corresponding to a certain face inclination is set by learning such that the image of a face that is inclined at an angle of ±15 degrees from the face inclination can be detected. In addition, a person's face is substantially symmetric with respect to the vertical direction. Therefore, when two face learning data, that is, face learning data FLD (FIG. 2A) corresponding to a face inclination of 0 degree and face learning data FLD (FIG. 2B) corresponding to a face inclination of 30 degrees are prepared for a face in the front direction in advance, it is possible to obtain face learning data FLD capable of detecting a face image in the entire face inclination range by rotating the two face learning data FLD at every 90 degrees. Similarly, when two face learning data, that is, face learning data FLD (FIG. 2C) corresponding to a face inclination of 0 degree and face learning data FLD (FIG. 2D) corresponding to a face inclination of 30 degrees are prepared for a face in the right direction in advance, it is possible to obtain face learning data FLD capable of detecting a face image in the entire face inclination range. In addition, for a face in the left direction, it is possible to obtain face learning data FLD capable of detecting a face image in the entire face inclination range by inverting face learning data FLD corresponding to the face in the right direction.

The facial organ learning data OLD is set so as to be associated with the kind of facial organ. In this embodiment, eyes (a right eye and a left eye) and a mouth are set as the kinds of facial organs. The facial organ learning data OLD is associated with only one organ inclination (specifically, 0 degree) for each kind of facial organ, unlike the face learning data FLD. In this embodiment, the organ inclination means the inclination (rotation angle) of a facial organ in an image plane, similar to the face inclination. That is, the organ inclination is the rotation angle of a facial organ on an axis that is vertical to the image plane. When the state in which a facial organ is disposed along the vertical direction of a target image is referred to as a reference state (organ inclination=0 degree), the organ inclination is represented by the rotation angle of a facial organ from the reference state in the clockwise direction, similar to the face inclination.

The internal memory 120 stores two facial organ learning data OLD shown in FIGS. 2E and 2F, that is, facial organ learning data OLD corresponding to an eye shown in FIG. 2E and facial organ learning data OLD corresponding to a mouth shown in FIG. 2F. Since the eye and the mouth are different kinds of subjects, the facial organ learning data OLD can be set so as to correspond to the kind of subject.

Similar to the face learning data FLD, facial organ learning data OLD corresponding to an organ inclination of 0 degree is set by learning such that the image of an organ that is inclined at an angle of ±15 degrees from 0 degree can be detected. In addition, in this embodiment, the right eye and the left eye are regarded as the same kind of subject, and a right eye area corresponding to the image of the right eye and a left eye area corresponding to the image of the left eye are detected using common facial organ learning data OLD. However, the right eye and the left eye may be regarded as different kinds of subjects, and dedicated facial organ learning data OLD for detecting the right eye area and the left eye area may be prepared.

The internal memory 120 (FIG. 1) further stores a predetermined size table ST. The size table ST includes information in which the type of image processing to be performed, the required accuracy of an organ area detecting process, which will be described below, and the size of an organ detecting image ODImg used are associated with each other. The content of the size table ST will be described in detail below.

### A-2. Image Processing

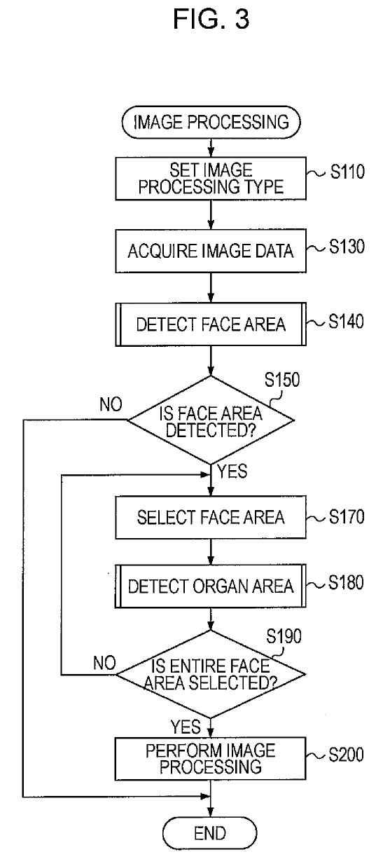

FIG. 3 is a flowchart illustrating the flow of image processing. In the image processing according to this embodiment, the type of image processing to be performed is set, and the set kind of image processing is performed.

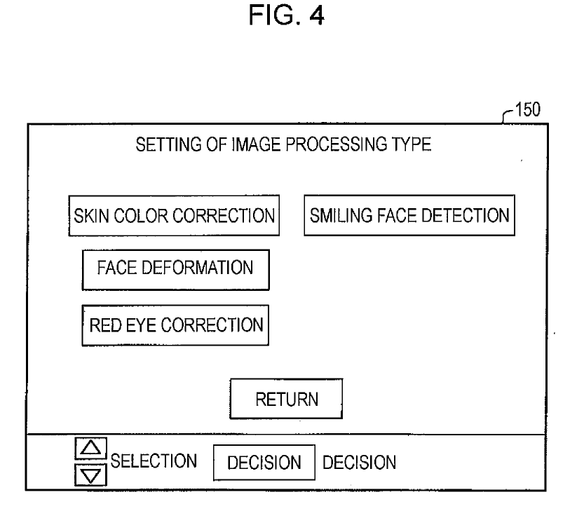

In Step S110 (FIG. 3) of the image processing, the process type setting unit 220 (FIG. 1) sets the type of image processing to be performed. Specifically, the process type setting unit 220 controls the display processing unit 310 (FIG. 1) to display a user interface for setting the type of image processing on the display unit 150. FIG. 4 is a diagram illustrating an example of the user interface for setting the type of image processing. As shown in FIG. 4, the printer 100 according to this embodiment includes four image processing types, such as skin color correction, face deformation, red eye correction, and smiling face detection.

The skin color correction is image processing that corrects the skin color of a person to a preferred skin color. The face deformation is image processing that deforms an image in a face area or an image in an image area including a face image that is set on the basis of the face area. The red eye correction is image processing that corrects the color of an eye in which a red eye phenomenon occurs into a natural eye color. The smiling face detection is image processing that detects a person's smiling face image.

When the user uses the operating unit 140 to select one kind of image processing, the designation acquiring unit 222 (FIG. 1) acquires information for specifying the selected type of image processing (hereinafter, referred to as ‘image processing type specifying information’), and the process type setting unit 220 sets the type of image processing specified by the image processing type specifying information as the type of image processing to be performed. In the type of image processing according to this embodiment, a predetermined process is performed using an organ area (or an image area set on the basis of the organ area) that is detected by an organ area detecting process (Step S180 in FIG. 3), which will be described below. Therefore, the set type of image processing can be represented as the purpose of use of the detection result of the organ area, and the image processing type specifying information can be represented as purpose specifying information for specifying the purpose of use of the detection result of the organ area. Therefore, the designation acquiring unit 222 that acquires the image processing type specifying information serves as a purpose specifying information acquiring unit according to the invention.

In Step S130 (FIG. 3), the image processing unit 200 (FIG. 1) acquires image data indicating an image to be subjected to image processing. In the printer 100 according to this embodiment, thumbnail images of the image file stored in the memory card MC that is inserted into the card slot 172 are displayed on the display unit 150. The user uses the operating unit 140 to select one image or a plurality of images to be processed while referring to the displayed thumbnail images. The image processing unit 200 acquires an image file including image data corresponding to the selected one or more images from the memory card MC and stores in a predetermined area of the internal memory 120. The acquired image data is referred to as the original image data, and an image represented by the original image data is referred to as an original image OImg.

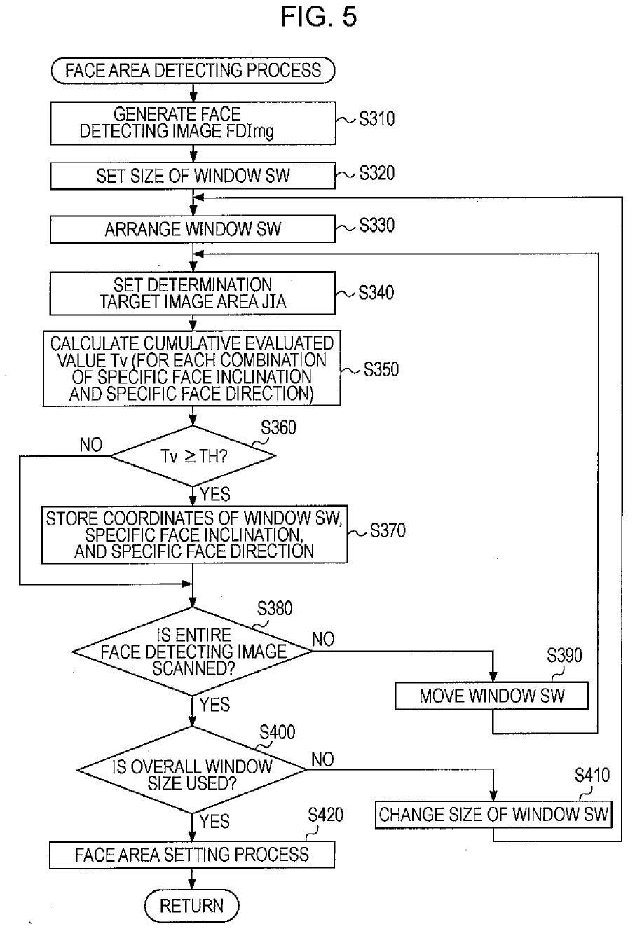

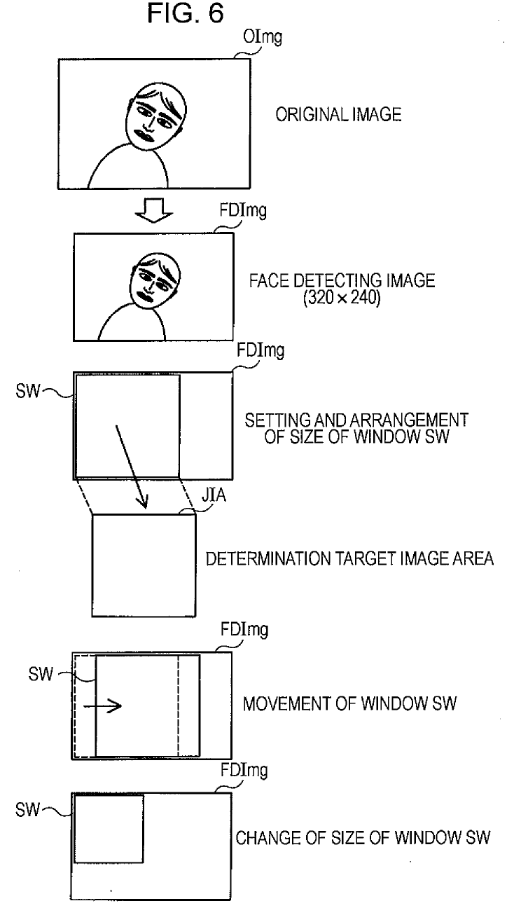

In Step S140 (FIG. 3), the area detecting unit 210 (FIG. 1) performs a face area detecting process. In the face area detecting process, an image area corresponding to a face image is detected as a face area FA. FIG. 5 is a flowchart illustrating the flow of the face area detecting process. FIG. 6 is a diagram illustrating the outline of the face area detecting process. In FIG. 6, the uppermost portion shows an example of the original image OImg.

In Step S310 of the face area detecting process (FIG. 5), the image generating unit 216 (FIG. 1) of the area detecting unit 210 generates face detecting image data indicating a face detecting image FDImg from the original image data indicating the original image OImg. In this embodiment, as shown in FIG. 6, the face detecting image FDImg has a size of 320×240 pixels. The image generating unit 216 changes the resolution of the original image data to generate face detecting image data indicating the face detecting image FDImg, if necessary.

In Step S320 (FIG. 5), the determination target setting unit 211 (FIG. 1) sets the size of a window SW for setting a determination target image area JIA (will be described below) to an initial value. In Step S330, the determination target setting unit 211 disposes the window SW at an initial position on the face detecting image FDImg. In Step S340, the determination target setting unit 211 sets an image area defined by the window SW that is arranged on the face detecting image FDImg to the determination target image area JIA that is determined whether to be an image area corresponding to a face image (hereinafter, referred to as ‘face determination’). In FIG. 6, a middle portion shows the arrangement of the window SW having an initial size at the initial position on the face detecting image FDImg and the setting of the image area defined by the window SW to the determination target image area JIA. In this embodiment, the size and the position of the square window SW are changed, and then the determination target image area JIA is set, which will be described below. The initial value of the size of the window SW is 240×240 pixels, which is a maximum size, and the initial position of the window SW is set such that the upper left corner of the window SW overlaps the upper left corner of the face detecting image FDImg. In addition, the window SW is arranged such that its inclination is 0 degree. As described above, when the state in which the upper direction of the window SW is aligned with the upper direction of a target image (face detecting image FDImg) is referred to as a reference state (inclination=0 degree), the inclination of the window SW means the rotation angle of the window SW from the reference state in the clockwise direction.

In Step S350 (FIG. 5), the evaluated value calculating unit 212 (FIG. 1) calculates a cumulative evaluated value Tv used for face determination for the determination target image area JIA, on the basis of image data corresponding to the determination target image area JIA. In this embodiment, face determination is performed for each combination of a predetermined specific face inclination and a predetermined specific face direction. That is, it is determined whether the determination target image area JIA is an image area corresponding to the face image having the specific face inclination and the specific face direction for each combination of a specific face inclination and a specific face direction. Therefore, the cumulative evaluated value Tv is calculated for each combination of a specific face inclination and a specific face direction. The specific face inclination is a predetermined face inclination. In this embodiment, 12 face inclinations (0 degree, 30 degrees, 60 degrees, . . . , 330 degrees) including a reference face inclination (face inclination=0 degree) and face inclinations that are arranged at an angular interval of 30 degrees from the reference face inclination are set as the specific face inclinations. In addition, the specific face direction is a predetermined face direction. In this embodiment, three face directions, that is, the front direction, the right direction, and the left direction are set as the specific face directions.

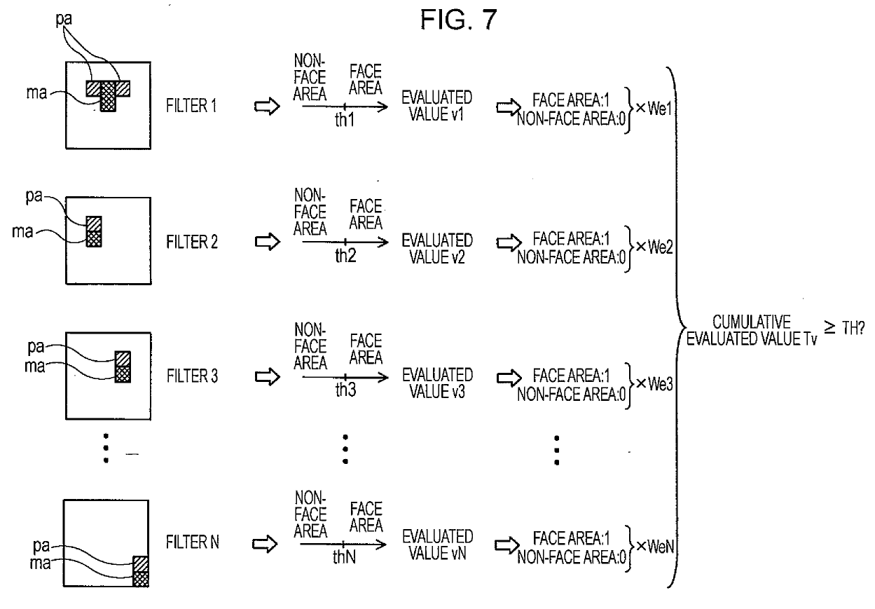

FIG. 7 is a diagram illustrating the outline of a method of calculating the cumulative evaluated value Tv used for face determination. In this embodiment, N filters (a filter 1 to a filter N) are used to calculate the cumulative evaluated value Tv. Each of the filters has the same aspect ratio as the window SW (that is, each of the filters has a square shape), and a positive area pa and a negative area ma are set in each of the filters. The evaluated value calculating unit 212 sequentially applies a filter X (X=1, 2, . . . , N) to the determination target image area JIA to calculate an evaluated value vX (that is, v1 to vN). Specifically, the evaluated value vX is obtained by subtracting the sum of the brightness values of pixels in a portion of the determination target image area JIA corresponding to the negative area ma of the filter X from the sum of the brightness values of pixels in another portion of the determination target image area JIA corresponding to the positive area pa of the filter X.

The calculated evaluated value vX is compared with a threshold value thX (that is, th1 to thN) that is set to correspond to the evaluated value vX. In this embodiment, if the evaluated value vX is larger than or equal to the threshold value thX, it is determined that the determination target image area JIA is an image area corresponding to a face image for the filter X, and the output value of the filter X is set to ‘1’. On the other hand, if the evaluated value vX is smaller than the threshold value thX, it is determined that the determination target image area JIA is not an image area corresponding to a face image for the filter X, and the output value of the filter X is set to ‘0’. A weighting coefficient WeX (that is, We1 to WeN) is set in each filter X, and the sum of the products of the output values and the weighting coefficients WeX of all the filters is calculated as the cumulative evaluated value Tv.

The aspect of the filter X, the threshold value thX, the weighting coefficient WeX, and a threshold value TH, which will be described, used for face determination are defined as the face learning data FLD in advance. That is, for example, the aspect of the filter X, the threshold value thX, the weighting coefficient WeX, and the threshold value TH defined in the face learning data FLD (see FIG. 2A) corresponding to a combination of a face in the front direction and a face inclination of 0 degree are used to calculate the cumulative evaluated value Tv corresponding to a combination of the face in the front direction and a face inclination of 0 degree and perform face determination. Similarly, the face learning data FLD (see FIG. 2B) corresponding to a combination of a face in the front direction and a face inclination of 30 degrees is used to calculate the cumulative evaluated value Tv corresponding to a combination of the face in the front direction and a face inclination of 30 degrees and perform face determination. In addition, in order to calculate the cumulative evaluated value Tv corresponding to a combination of a face in the front direction and another specific face inclination and perform face determination, the evaluated value calculating unit 212 generates face learning data FLD corresponding to a combination of the face in the front direction and another specific face inclination, on the basis of face learning data FLD (FIG. 2A) corresponding to a combination of the face in the front direction and a face inclination of 0 degree and face learning data FLD (FIG. 2B) corresponding to a combination of the face in the front direction and a face inclination of 30 degrees, and uses the generated face learning data. Necessary face learning data FLD is generated for a face in the right direction and a face in the left direction on the basis of the face learning data FLD previously stored in the internal memory 120 by the same method as described above. The face learning data FLD according to this embodiment is for calculating the evaluated value indicating that the determination target image area JIA is an image data corresponding to a face image. Therefore, the face learning data FLD corresponds to evaluating data according to the invention.

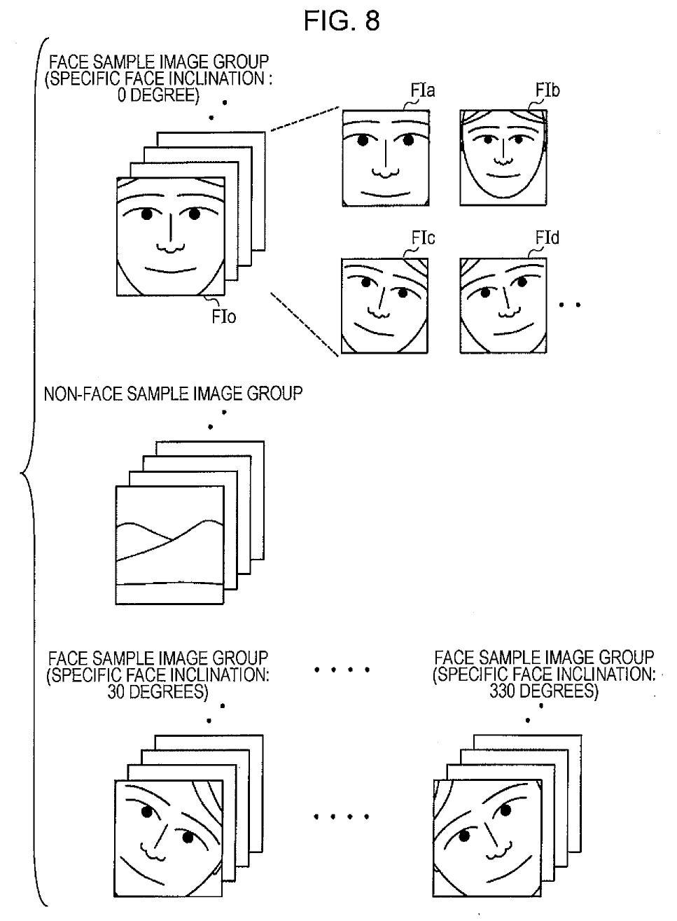

The face learning data FLD is set by learning using sample images. FIG. 8 is a diagram illustrating an example of the sample images that are used for learning for setting the face learning data FLD corresponding to a face in the front direction. The followings are used for learning: a face sample image group including a plurality of face sample images that have been known to correspond to a face in the front direction; and a non-face sample image group including a plurality of non-face sample images that have been known not to correspond to the face in the front direction.

The setting of the face learning data FLD corresponding to the face in the front direction by learning is performed for every specific face inclination. Therefore, as shown in FIG. 8, face sample image groups corresponding to 12 specific face inclinations are prepared. For example, the face learning data FLD for a specific face inclination of 0 degree is set using a non-face sample image group and a face sample image group corresponding to a specific face inclination of 0 degree, and the face learning data FLD for a specific face inclination of 30 degrees is set using a non-face sample image group and a face sample image group corresponding to a specific face inclination of 30 degrees.

The face sample image group corresponding to each specific face inclination includes a plurality of face sample images (hereinafter, referred to as ‘basic face sample images FIo’) in which the ratio of the size of a face image to an image size is within a predetermined range and the inclination of the face image is equal to a specific face inclination. In addition, the face sample image group includes images obtained by reducing or enlarging at least one basic face sample image FIo at a magnification of 0.8 to 1.2 (for example, images FIa and FIb in FIG. 8) or images obtained by changing the face inclination of the basic face sample image FIo in the angular range of −15 degrees to +15 degrees (for example, images FIc and FId in FIG. 8).

The learning using the sample images is performed by, for example, a method of using a neural network, a method of using boosting (for example, adaboosting), or a method of using a support vector machine. For example, when learning is performed by the method of using a neural network, the evaluated value vX (that is, v1 to vN) is calculated for each filter X (that is, a filter 1 to a filter N (see FIG. 7)) using all the sample images included in a non-face sample image group and a face sample image group corresponding to a certain specific face inclination, and a threshold value thx (that is, th1 to thN) that achieves a predetermined face detection ratio is set. The face detection ratio means the ratio of the number of face sample images that are determined as images corresponding to a face image by threshold value determination using the evaluated value vX to the total number of face sample images in the face sample image group.

Then, the weighting coefficient WeX (that is, We1 to WeN) set to each filter X is set to an initial value, and the cumulative evaluated value Tv for one sample image selected from the face sample image group and the non-face sample image group is calculated. In the face determination, when the cumulative evaluated value Tv calculated for a certain image is larger than or equal to a predetermined threshold value TH, the image is determined to correspond to the face image, which will be described below. In the learning process, the value of the weighting coefficient WeX set to each filter X is corrected on the basis of the determination result of a threshold value by the cumulative evaluated value Tv that is calculated for the selected sample image (a face sample image or a non-face sample image). Then, the selection of a sample image, the determination of a threshold value by the cumulative evaluated value Tv calculated for the selected sample image, and the correction of the value of the weighting coefficient WeX on the basis of the determination result are repeatedly performed on all the sample images in the face sample image group and the non-face sample image group. In this way, the face learning data FLD corresponding to a combination of a face in the front direction and a specific face inclination is set.

Similarly, the face learning data FLD corresponding to another specific face direction (the right direction or the left direction) is set by learning using a face sample image group including a plurality of face sample images that have been known as images corresponding to a face in the right direction (or in the left direction) and a non-face sample image group including a plurality of non-face sample images that have been known as images not corresponding to a face in the right direction (or the left direction).

When the cumulative evaluated value Tv is calculated for each combination of a specific face inclination and a specific face direction for the determination target image area JIA (Step S350 in FIG. 5), the determining unit 213 (FIG. 1) compares the cumulative evaluated value Tv with the threshold value TH that is set for each combination of a specific face inclination and a specific face direction (Step S360). If the cumulative evaluated value Tv is larger than or equal to the threshold value TH set for each combination of a specific face inclination and a specific face direction, the area detecting unit 210 determines that the determination target image area JIA is an image area corresponding to a face image having the specific face inclination and the specific face direction, and stores the position of the determination target image area JIA, that is, the coordinates of the window SW that is currently set, the specific face inclination, and the specific face direction (Step S370). If the cumulative evaluated value Tv is not larger than the threshold value TH for any combination of a specific face inclination and a specific face direction, Step S370 is skipped.

In Step S380 (FIG. 5), the area detecting unit 210 (FIG. 1) determines whether the entire face detecting image FDImg is scanned by the window SW having a size that is currently set. If it is determined that the entire face detecting image FDImg is not scanned yet, the determination target setting unit 211 (FIG. 1) moves the window SW in a predetermined direction by a predetermined amount (Step S390). A lower part of FIG. 6 shows the movement of the window SW. In this embodiment, in Step S390, the window SW is moved a distance corresponding to 20% of the size of the window SW in the horizontal direction to the right side. When the window SW is disposed at a position where it cannot move any further to the right side, in Step S390, the window SW returns to the left end of the face detecting image FDImg, and is moved down a distance corresponding to 20% of the size of the window SW in the vertical direction. When the window SW is disposed at a position where it cannot move down any further, it is determined that the entire face detecting image FDImg is scanned. After the window SW is moved (Step S390), the processes after Step S340 are performed on the moved window SW.

When it is determined in Step S380 (FIG. 5) that the entire face detecting image FDImg is scanned by the window SW having the currently set size, it is determined whether the entire window SW having a predetermined size is used (Step S400). In this embodiment, the window SW has a total of 15 sizes, that is, a size of 240×240 pixels, which is an initial value (a maximum size), a size of 213×213 pixels, a size of 178×178 pixels, a size of 149×149 pixels, a size of 124×124 pixels, a size of 103×103 pixels, a size of 86×86 pixels, a size of 72×72 pixels, a size of 60×60 pixels, a size of 50×50 pixels, a size of 41×41 pixels, a size of 35×35 pixels, a size of 29×29 pixels, a size of 24×24 pixels, and a size of 20×20 pixels (a minimum size). If it is determined that there is a portion of the SW that is not used, the determination target setting unit 211 (FIG. 1) changes the size of the window SW from the currently set size to the next smaller size (Step S410). That is, the size of the window SW is set to the maximum size at the beginning, and is then sequentially changed to the smaller size. After the size of the window SW is changed (Step S410), the processes after Step S330 are performed on the window SW whose size is changed.

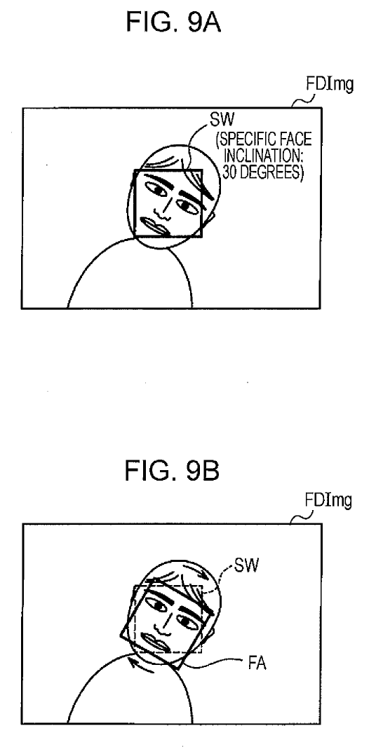

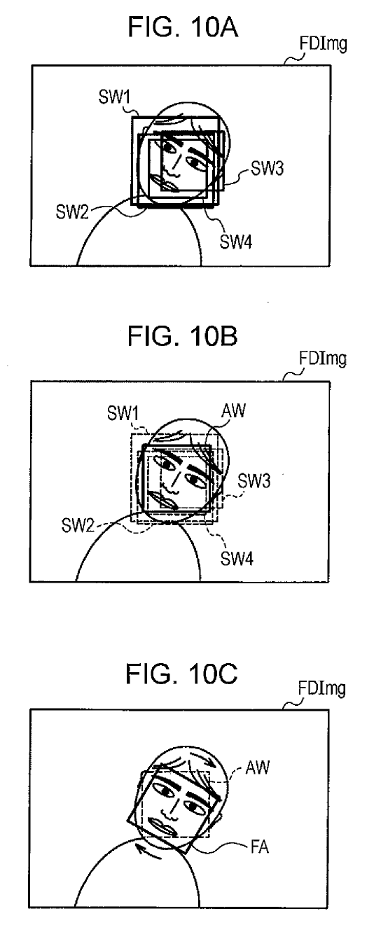

When it is determined in Step S400 (FIG. 5) that the entire window SW having a predetermined size is used, the area setting unit 214 (FIG. 1) performs a face area setting process (Step S420). FIGS. 9A and 9B and FIGS. 10A to 10C are diagrams illustrating the outline of the face area setting process. When it is determined in Step S360 of FIG. 5 that the cumulative evaluated value Tv is larger than or equal to the threshold value TH, the area setting unit 214 sets the face area FA as an image area corresponding to the face image on the basis of the specific face inclination and the coordinates of the window SW stored in Step S370. Specifically, if the stored specific face inclination is 0 degree, the image area (that is, the determination target image area JIA) defined by the window SW is set as the face area FA without any change. On the other hand, if the stored specific face inclination is not 0 degree, the inclination of the window SW is changed to be equal to a specific face inclination (that is, the window SW is rotated on a predetermined point (for example, the center of gravity of the window SW) by a specific face inclination in the clockwise direction), and the image area defined by the window SW whose inclination is changed is set as the face area FA. For example, as shown in FIG. 9A, if it is determined that the cumulative evaluated value Tv is larger than or equal to the threshold value TH for a specific face inclination of 30 degrees, as shown in FIG. 9B, the inclination of the window SW is changed 30 degrees, and the image area defined by the window SW whose inclination is changed is set as the face area FA.

In addition, when a plurality of windows SW that partially overlap each other for a specific face inclination are stored in Step S370 (FIG. 5), the area setting unit 214 (FIG. 1) sets a new window (hereinafter, referred to as an ‘average window AW’) having the average value of the sizes of the windows SW, using the average coordinates of the coordinates of a predetermined point (for example, the center of gravity of the window SW) of each window SW as the center of gravity. For example, as shown in FIG. 10A, when four windows SW (SW1 to SW4) that partially overlap each other are stored, as shown in FIG. 10B, one average window AW having the average value of the sizes of the four windows SW is defined using the average coordinates of the coordinates of the centers of gravity of the four windows SW as the center of gravity. In this case, similar to the above, when the stored specific face inclination is 0 degree, the image area defined by the average window AW is set as the face area FA without any change. On the other hand, when the stored specific face inclination is not 0 degree, the inclination of the average window AW is changed to be equal to a specific face inclination (that is, the average window AW is rotated on a predetermined point (for example, the center of gravity of the average window AW) by a specific face inclination in the clockwise direction), and the image area defined by the average window AW whose inclination is changed is set as the face area FA (see FIG. 10C).

As shown in FIGS. 9A and 9B, even when one window SW that does not overlap other windows SW is stored, the one window SW can be analyzed as the average window AW, similar to when a plurality of windows SW shown in FIGS. 10A to 10C that partially overlap each other are stored.

In this embodiment, since the face sample image group (see FIG. 8) used for learning includes images obtained by reducing or enlarging the basic face sample image FIo at a magnification of 0.8 to 1.2 (for example, the images FIa and FIb in FIG. 8), the face area FA can be detected even when the size of the face image with respect to the size of the window SW is slightly larger or smaller than that of the basic face sample image FIo. Therefore, in this embodiment, even though only fifteen discrete sizes are set as the standard sizes of the window SW, it is possible to detect the face area FA from a face image having any size. Similarly, in this embodiment, since the face sample image group used for learning includes images obtained by changing the face inclination of the basic face sample image FIo in the angular range of −15 degrees to +15 degrees (for example, the images FIc and FId in FIG. 8), the face area FA can be detected even when the inclination of the face image with respect to the window SW is slightly different from that of the basic face sample image FIo. Therefore, in this embodiment, even though only twelve discrete angles are set as the specific face inclinations, it is possible to detect the face area FA from a face image in the entire angular range.

In the face area detecting process (Step S140 in FIG. 3), when no face area FA is detected (Step S150: No), the image processing ends. On the other hand, when at least one face area FA is detected (Step S150: Yes), the area detecting unit 210 (FIG. 1) selects one of the detected face areas FA (Step S170).

In Step S180 (FIG. 3), the area detecting unit 210 (FIG. 1) performs an organ area detecting process. The organ area detecting process detects an image area corresponding to a facial organ image in the selected face area FA as an organ area. As described above, in this embodiment, the facial organ means three organs, such as the right eye, the left eye, and the mouth, and the area detecting unit 210 detects the organ areas, a right eye area EA(r) corresponding to a right eye image, a left eye area EA(l) corresponding to a left eye image, and a mouth area MA corresponding to a mouth image.

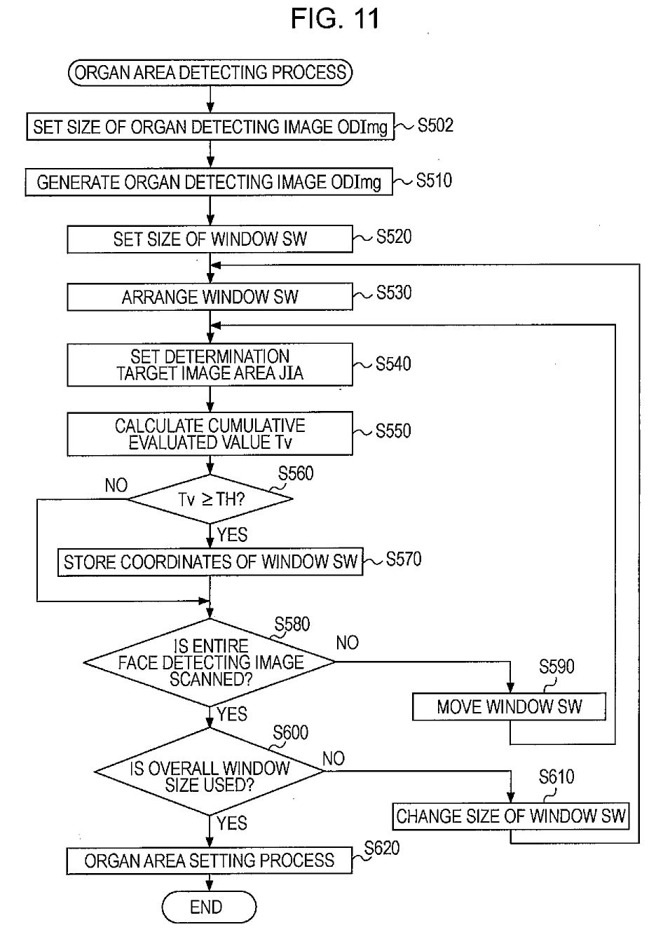

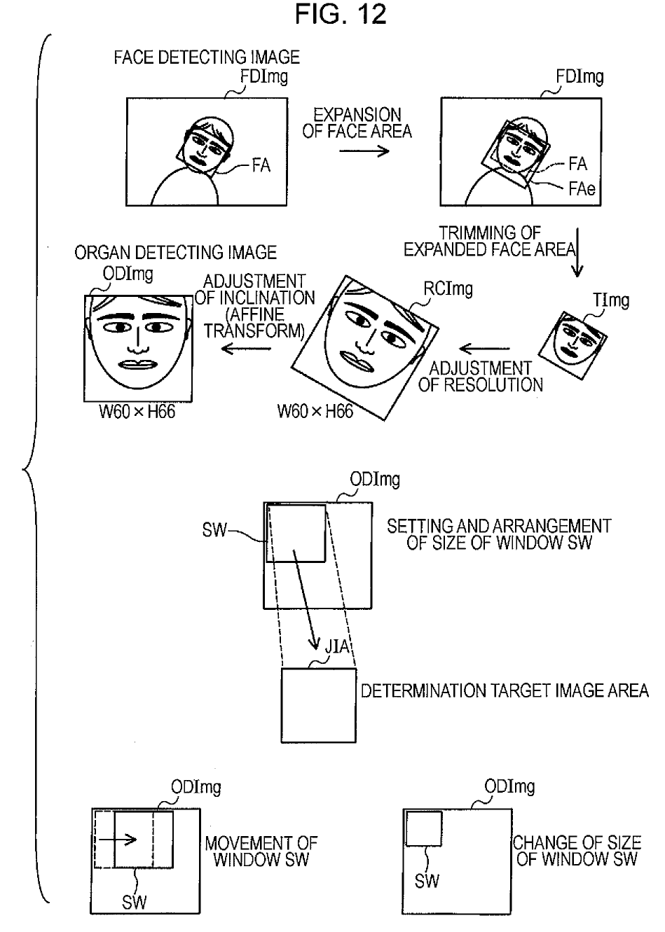

FIG. 11 is a flowchart illustrating the flow of the organ area detecting process. FIG. 12 is a diagram illustrating the outline of the organ area detecting process. In Step S502 (FIG. 11) of the organ area detecting process, the size setting unit 217 (FIG. 1) sets the size of the organ detecting image ODImg used for the organ area detecting process with reference to the size table ST.

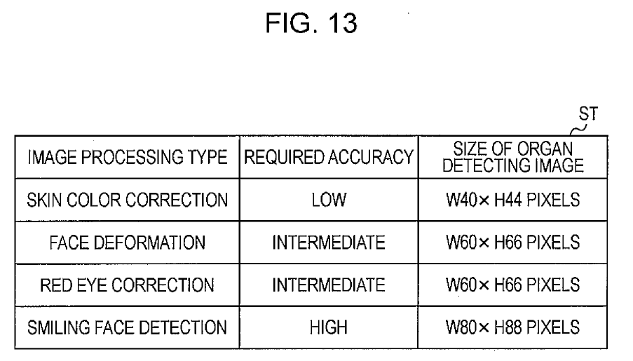

FIG. 13 is a diagram illustrating an example of the content of the size table ST. The size table ST includes information in which the type of image processing to be performed, the required accuracy of the organ area detecting process, and the size of the organ detecting image ODImg used are associated with each other. As shown in FIG. 13, in the size table ST, skin color correction is associated with relatively low accuracy as the required accuracy of the organ area detecting process and a relatively small size of 40×44 pixels as the size of the organ detecting image ODImg. In this embodiment, the skin color correction does not refer to the organ area. Therefore, the skin color correction is associated with relatively low accuracy as the required accuracy of the organ area detecting process. In general, as the size of the organ detecting image ODImg used is increased, the accuracy of the organ area detecting process is increased, and the process time tends to increase. Therefore, in the size table ST, as the required accuracy of the organ area detecting process is increased, the size of the organ detecting image ODImg is increased. For this reason, the skin color correction is associated with the organ detecting image ODImg having a relatively small size. When the type of image processing to be performed is skin color correction, the organ area detecting process may not be performed. In this case, the size table ST does not include information for specifying the required accuracy or the size of the organ detecting image ODImg corresponding to the skin color correction.

In the size table ST (FIG. 13), the smiling face detection is associated with relatively high accuracy as the required accuracy of the organ area detecting process and a relative large size of 80×88 pixels as the size of the organ detecting image ODImg. In this embodiment, during the smiling face detection, the contour of the organ area (mouth area MA) detected by the organ area detecting process is detected, which will be described below. Therefore, the smiling face detection is associated with relatively high accuracy as the required accuracy of the organ area detecting process and the organ detecting image ODImg having a relative large size.

In the size table ST (FIG. 13), face deformation and red eye correction are associated with intermediate accuracy as the required accuracy of the organ area detecting process and an intermediate of 60×66 pixels as the size of the organ detecting image ODImg. In this embodiment, during the face deformation, the face area FA is adjusted on the basis of the positional relationship between the organ areas detected by the organ area detecting process. Therefore, the face deformation is associated with intermediate accuracy as the required accuracy of the organ area detecting process and the organ detecting image ODImg having an intermediate size. In addition, during the red eye correction, red eye images are detected from the organ areas (the right eye area EA(r) and the left eye area EA(l)) detected by the organ area detecting process. Therefore, the red eye correction is associated with intermediate accuracy as the required accuracy of the organ area detecting process and the organ detecting image ODImg having an intermediate size.

The size setting unit 217 (FIG. 1) sets the size of the organ detecting image ODImg associated with the type of image processing to be performed, which is set in Step S110 (FIG. 3), as the size of the organ detecting image ODImg to be used in the size table ST (FIG. 13). As described above, information (image processing type specifying information) for specifying the set type of image processing may be purpose specifying information for specifying the purpose of use of the detection result of the organ area. Therefore, the size setting unit 217 may set the size of the organ detecting image ODImg on the basis of the purpose specifying information.

In Step S510 of the organ area detecting process (FIG. 11), the image generating unit 216 (FIG. 1) generates organ detecting image data indicating the organ detecting image ODImg from face detecting image data indicating the face detecting image FDImg. As shown in an upper part of FIG. 12, first, the image generating unit 216 sets, as an enlarged face area FAe, a rectangular image area that is defined by a frame obtained by enlarging an edge frame of a rectangular face area FA in the face detecting image FDImg. When the edge frame of the face area FA is enlarged, the enlargement direction and the magnification of the edge frame are predetermined. The enlarged face area FAe corresponds to a specific image area according to the invention. Then, the image generating unit 216 trims the enlarged face area FAe from the face detecting image FDImg to generate a trimmed image TImg, and adjusts the resolution of the trimmed image TImg to generate a resolution-adjusted image RCImg. The resolution adjustment is performed by changing the resolution such that the size of the rectangular resolution-adjusted image RCImg is equal to that of the organ detecting image ODImg set in Step S502. For example, when the type of image processing to be performed is face deformation, the resolution-adjusted image RCImg has a size of 60×66 pixels (see FIG. 13). In addition, the image generating unit 216 adjusts the inclination of the resolution-adjusted image RCImg to generate the organ detecting image ODImg. The inclination adjustment is performed by affine transform that rotates the resolution-adjusted image RCImg by a specific face inclination associated with the face learning data FLD used to detect the face area FA in the counterclockwise direction.

When the organ detecting image ODImg is generated in this way, the organ detecting image ODImg corresponds to an image area (the enlarged face area FAe) having a size that is larger than that of the face area FA in the face detecting image FDImg, and has a size (see FIG. 13) that is associated with the type of image processing to be performed. In addition, the inclination of the face image in the organ detecting image ODImg is about 0 degree (specifically, in the range of 15 degrees from 0 degree in the clockwise direction and the counterclockwise direction).

An organ area is detected from the organ detecting image ODImg by the same method as that detecting the face area FA from the face detecting image FDImg. That is, as shown in a lower part of FIG. 12, the rectangular window SW is arranged on the organ detecting image ODImg while the size and position thereof are changed (Steps S520, S530, and S580 to S610 in FIG. 11), and the image area defined by the arranged window SW is set as the determination target image area JIA that is determined whether to be an organ area corresponding to a facial organ image (hereinafter, referred to as ‘organ determination’) (Step S540 in FIG. 11). The size of the window SW is predetermined according to the size of the organ detecting image ODImg for each kind of organ (eyes and a mouth). That is, when the size of the organ detecting image ODImg is determined according to the type of image processing to be performed, the size of the window SW is also determined.

When the determination target image area JIA is set, the cumulative evaluated value Tv used for organ determination is calculated for each of the detected organs in the determination target image area JIA, using the facial organ learning data OLD (FIG. 1) (Step S550 in FIG. 11). The facial organ learning data OLD defines the aspect of the filter X, the threshold value thX, the weighting coefficient WeX, and the threshold value TH (see FIG. 7) used for the calculation of the cumulative evaluated value Tv and organ determination. Similar to the learning for setting the face learning data FLD, learning for setting the facial organ learning data OLD is performed using an organ sample image group including a plurality of organ sample images that have been known to include a facial organ image; and a non-organ sample image group including a plurality of non-organ sample images that have been known to include no facial organ image.

In the face area detecting process (Step S140 in FIG. 3), the cumulative evaluated value Tv is calculated for each specific face inclination, and face determination is performed for each specific face inclination. In contrast, in the organ area detecting process, only one cumulative evaluated value Tv corresponding to an inclination of 0 degree is calculated for one determination target image area JIA using the facial organ learning data OLD corresponding to an inclination of 0 degree, and organ determination is performed on only an organ image corresponding to an inclination of 0 degree. This is because the inclination of the face image in the organ detecting image ODImg is about 0 degree and the inclination of the facial organ is substantially equal to the inclination of the entire face, as described above.

If the cumulative evaluated value Tv calculated for each of the detected organs is larger than or equal to a predetermined threshold value TH, the determination target image area JIA is regarded as an image area corresponding to the organ image, and the position of the determination target image area JIA, that is, the coordinates of the window SW that is currently set are stored (Step S570 in FIG. 11). On the other hand, if the cumulative evaluated value Tv is smaller than the threshold value TH, Step S570 is skipped. After the entire organ detecting image ODImg is scanned by the window SW having a predetermined size, an organ area setting process is performed (Step S620 in FIG. 11). The organ area setting process sets an average window AW and sets an image area defined by the average window AW as the organ area, similar to the face area setting process (see FIG. 5).

When the organ area detecting process (Step S180 in FIG. 3) is completed, the area detecting unit 210 (FIG. 1) determines whether there is a face area FA that has not been selected yet in Step S170 (Step S190). If it is determined that there is a face area FA that has not been selected yet (Step S190: No), the process returns to Step S170 to select one of the face areas FA that have not been selected, and the processes after Step S180 are performed. On the other hand, if it is determined that all the face areas FA are selected (Step S190: Yes), the process proceeds to Step S200.

In Step S200 (FIG. 3), the image processing unit 200 (FIG. 1) performs the image processing that is set in Step S110. Specifically, when the type of image processing to be performed is skin color correction, a person's skin color in the face area FA or an image area including the face image that is set on the basis of the face area FA is corrected to a preferred color. When the type of image processing to be performed is face deformation, the face area FA is adjusted on the basis of the positional relationship between the detected organ areas (the right eye area EA(r), the left eye area EA(l), and the mouth area MA), and an image in the adjusted face area FA or an image in an image area including the face image that is set on the basis of the adjusted face area FA is deformed. When the type of image processing to be performed is red eye correction, a red eye image is detected from the organ areas (the right eye area EA(r) and the left eye area EA(l)) detected from the face area FA, and the color of the image is corrected so as to be close to the natural eye color. When the type of image processing to be performed is smiling face detection, the contours of the detected face area FA and the detected organ area (the mouth area MA) are detected. For example, it is determined whether an image in the face area FA is a smiling face image by evaluating the angle of the mouth (smiling face determination). A technique required for smiling face determination is disclosed in, for example, JP-A-2004-178593 or Soejima Yoshitaka, ‘Study for Moving Object Tracking in Scene Changing Environment’, Feb. 15, 1998.

As described above, in the image processing performed by the printer 100 according to this embodiment, the face area FA is detected from the face detecting image FDImg, the organ detecting image ODImg including a face image that is inclined in a predetermined angular range (about 0 degree) in an image plane is generated on the basis of the detection result of the face area FA, and an organ area is detected from the face area FA on the basis of image data indicating the organ detecting image ODImg. In this case, the organ detecting image ODImg is an image including a face image that is inclined at an angle of about 0 degree in the image plane. Therefore, when the organ area is detected, only the facial organ learning data OLD corresponding to an organ inclination of 0 degree is used, but facial organ learning data OLD corresponding to the other organ inclinations are not used. Therefore, in the image processing performed by the printer 100 according to this embodiment, it is possible to improve the accuracy of the process of detecting an organ area from the face area FA and increase the speed of the detecting process. In addition, since it is necessary to prepare only the facial organ learning data OLD corresponding to an organ inclination of 0 degree, it is possible to improve the efficiency of a preparing operation (for example, the setting of the facial organ learning data OLD by learning) and effectively use memory capacity.

Furthermore, in the image processing performed by the printer 100 according to this embodiment, the size of the organ detecting image ODImg is determined according to the type of image processing to be performed. Therefore, when type of image processing to be performed is set, the organ area detecting process is performed using the organ detecting image ODImg having a predetermined size, regardless of the size of the detected face area FA, and windows SW having a plurality of predetermined sizes are used. Therefore, in the image processing performed by the printer 100 according to this embodiment, it is possible to improve the accuracy of the process of detecting an organ area from the face area FA and increase the speed of the detecting process.

Further, in the image processing performed by the printer 100 according to this embodiment, the size of the organ detecting image ODImg is set on the basis of information (image processing type specifying information) for specifying the type of image processing to be performed. That is, the size of the organ detecting image ODImg is set on the basis of purpose specifying information for specifying the purpose of use of the detection result of the organ area. Therefore, in the image processing performed by the printer 100 according to this embodiment, it is possible to perform the organ area detecting process using the organ detecting image ODImg having a necessary and sufficient size according to the type of image processing to be performed. As a result, it is possible to improve the accuracy of the process of detecting an organ area from the face area FA and increase the speed of the detecting process.

Furthermore, in the image processing performed by the printer 100 according to this embodiment, the enlarged face area FAe that is defined by a frame obtained by enlarging an edge frame of the face area FA is set as the trimmed image TImg, and the organ detecting image ODImg is generated on the basis of the trimmed image TImg. Therefore, the organ detecting image ODImg can certainly include a facial organ image, and it is possible to improve the accuracy of the process of detecting an organ area from the face area FA.

### B. Modifications

The invention is not limited to the above-described examples and embodiment, but various modifications and changes of the invention can be made without departing from the scope and spirit of the invention. For example, the following modifications can be made.

### B1. First Modification

In the above-described embodiment, when the organ detecting image ODImg is generated (see FIG. 12), the enlarged face area FAe obtained by enlarging the face area FA is trimmed to generate the trimmed image TImg. However, the face area FA may be trimmed to generate the trimmed image TImg, without enlarging the face area FA. In addition, the resolution of the trimmed image TImg is not necessarily adjusted, but the inclination of the trimmed image TImg may be adjusted to generate the organ detecting image ODImg. The inclination of the resolution-adjusted image RCImg is not necessarily adjusted, but the resolution-adjusted image RCImg may be used as the organ detecting image ODImg.

In the above-described embodiment, affine transform is performed to rotate the resolution-adjusted image RCImg in the counterclockwise direction by a specific face inclination that is associated with the face learning data FLD used to detect the face area FA such that the inclination of a face image in the organ detecting image ODImg is about 0 degree, thereby adjusting the inclination of the resolution-adjusted image RCImg. However, the inclination of the resolution-adjusted image RCImg may be adjusted such that the inclination of the face image in the organ detecting image ODImg has a predetermined value (a predetermined range including the predetermined value), not 0 degree. In this case, only one facial organ learning data element OLD corresponding to the predetermined inclination is prepared. Therefore, it is possible to perform the organ area detecting process using only the facial organ learning data OLD.

### B2. Second Modification

In the above-described embodiment, the size of the organ detecting image ODImg is determined according to the type of image processing to be performed (see FIG. 13). However, the organ detecting image ODImg may have a constant size regardless of the type of image processing. In addition, the required accuracy of the organ area detecting process may be designated by the user or automatically, and the size of the organ detecting image ODImg may be set according to the designated required accuracy. Furthermore, the size of the organ detecting image ODImg may be designated by the user or automatically, and the size of the organ detecting image ODImg may be set to the designated value.

The types of image processing according to the above-described embodiment, and the required accuracy and the size of the organ detecting image ODImg associated with the types of image processing are just illustrative. However, the types of image processing that can be performed by the printer 100 may include image processing types other than those shown in FIG. 13, and some of the types of image processing shown in FIG. 13 may not be performed. In addition, the required accuracy and the size of the organ detecting image ODImg may be arbitrarily changed. The type of image processing to be performed is not set by the user, but it may be automatically set.

### B3. Third Modification

The face area detecting process (FIG. 5) and the organ area detecting process (FIG. 11) according to the above-described embodiment are just illustrative, but various modifications thereof can be made. For example, the size of the face detecting image FDImg (see FIG. 6) is not limited to 320×240 pixels, but the face detecting image FDImg may have other sizes. The original image OImg may be used as the face detecting image FDImg. In addition, the size, the movement direction, and the movement amount (movement pitch) of the window SW used are not limited to the above. In the above-described embodiment, the size of the face detecting image FDImg is fixed, and the window SW having one of a plurality of sizes is arranged on the face detecting image FDImg to set the determination target image area JIA having one of a plurality of sizes. However, the face detecting images FDImg having a plurality of sizes may be generated, and the window SW having a fixed size may be arranged on the face detecting image FDImg to set the determination target image area JIA having one of a plurality of sizes.

In the above-described embodiment, the cumulative evaluated value Tv is compared with the threshold value TH to perform face determination and organ determination (see FIG. 7). However, other methods including a method of using a plurality of determining units to perform face determination and organ determination may be used. A learning method used to set the face learning data FLD and the facial organ learning data OLD may vary depending on the face and organ determining method. The learning method is not necessarily used to perform face determination and organ determination, but other methods, such as pattern matching, may be used to perform face determination and organ determination.

In the above-described embodiment, 12 specific face inclinations are set at an angular interval of 30 degrees. However, specific face inclinations more or less than 12 specific face inclinations may be set. In addition, the specific face inclinations are not necessarily set, but face determination may be performed for a face inclination of 0 degree. In the above-described embodiment, the face sample image group includes images obtained by enlarging, reducing, and rotating the basic face sample image FIo, but the face sample image group does not necessarily include the images.

In the above-described embodiment, when it is determined that the determination target image area JIA defined by the window SW having a certain size is an image area corresponding to a face image (or a facial organ image) by face determination (or organ determination), the window SW having a size that is reduced from the size at a predetermined reduction ratio or more may be arranged out of the determination target image area JIA that is determined as an image area corresponding to the face image. In this way, it is possible to improve a process speed.

In the above-described embodiment, image data stored in the memory card MC is set as the original image data, but the original image data is not limited to the image data stored in the memory card MC. For example, the original image data may be image data acquired through a network.

In the above-described embodiment, the right eye, the left eye, and the mouth are set as the kinds of facial organs, and the right eye area EA(r), the left eye area EA(l), and the mouth area MA are detected as the organ areas. However, any organ of the face may be set as the kind of facial organ. For example, one or two of the right eye, the left eye, and the mouth may be set as the kind of facial organ. In addition, other organs (for example, a nose or an eyebrow) may be set as the kind of facial organ, in addition to the right eye, the left eye, and the mouth, or instead of at least one of the right eye, the left eye, and the mouth, and areas corresponding to the images of the organs may be selected as the organ areas.

In the above-described embodiment, the face area FA and the organ area have rectangular shapes, but the face area FA and the organ area may have shapes other than the rectangle.

In the above-described embodiment, image processing performed by the printer 100, serving as an image processing apparatus, is described. However, a portion or the entire image processing may be performed by other types of image processing apparatuses, such as a personal computer, a digital still camera, and a digital video camera. In addition, the printer 100 is not limited to an ink jet printer, but other types of printers, such as a laser printer and a dye sublimation printer, may be used as the printer 100.

In the above-described embodiment, some of the components implemented by hardware may be substituted for software. On the contrary, some of the components implemented by software may be substituted for hardware.

When some or all of the functions of the invention are implemented by software, the software (computer program) may be stored in a computer readable recording medium and then provided. In the invention, the ‘computer readable recording medium’ is not limited to a portable recording medium, such as a flexible disk or a CD-ROM, but examples of the computer readable recording medium include various internal storage devices provided in a computer, such as a RAM and a ROM, and external storage devices fixed to the computer, such as a hard disk.

The present application claims the priority based on a Japanese Patent Application No. 2008-079246 filed on Mar. 25, 2008, the disclosure of which is hereby incorporated by reference in its entirety.

What is claimed is:

1. An image processing apparatus comprising:
a face area detecting unit detects a face area corresponding to a face image in a target image;
an image generating unit that generates an, organ detecting image including the face image which is inclined in a predetermined angular range in an image plane on the basis of the detection result of the face area; and
an organ area detecting unit that detects an organ area corresponding to a facial organ image in the face area on the basis of image data indicating the organ detecting image.

2. The image processing apparatus according to claim 1,
wherein the image generating unit sets a specific image area including the face area on the basis of the face area, and adjusts the inclination of the specific image area to generate the organ detecting image.

3. The image processing apparatus according to claim 2,
wherein the face area detecting unit includes:
a determination target setting unit that sets a determination target image area in an image area on the target image;
a storage unit that stores a plurality of evaluating data which are associated with different inclination values and are used to calculate an evaluated value indicating that the determination target image area is certainly an image area corresponding to a face image having an inclination value in a predetermine range including the inclination value associated with the evaluating data;
an evaluated value calculating unit that calculates the evaluated value on the basis of the evaluating data and image data corresponding to the determination target image area; and
an area setting unit that sets the face area on the basis of the evaluated value, and the position and the size of the determination target image area, and
the image generating unit sets an adjustment amount for adjusting the inclination of the specific image area, on the basis of the inclination value associated with the evaluating data used to detect the face area.

4. The image processing apparatus according to claim 3,
wherein the area setting unit determines whether the determination target image area is an image area corresponding to the face image having an inclination value in a predetermine range including the inclination value associated with the evaluating data, on the basis of the evaluated value, and
when it is determined that the determination target image area is an image area corresponding to the face image having an inclination value in a predetermine range including the inclination value associated with the evaluating data, the area setting unit sets the face area on the basis of the position and the size of the determination target image area.

5. The image processing apparatus according to claim 2,
wherein the image generating unit adjusts the resolution of the specific image area such that the organ detecting image has a predetermined size, thereby generating the organ detecting image.

6. The image processing apparatus according to claim 2,
wherein the image generating unit sets, as the specific image area, an image area that is defined by a frame obtained by enlarging an edge frame of the face area in the target image.

7. The image processing apparatus according to claim 1,
wherein the kinds of facial organs include at least one of a right eye, a left eye, and a mouth.

8. An image processing method comprising:
detecting a face area corresponding to a face image in a target image;
generating an organ detecting image including the face image which is inclined in a predetermined angular range in an image plane on the basis of the detection result of the face area; and
detecting an organ area corresponding to a facial organ image in the face area on the basis of image data indicating the organ detecting image.

9. A computer program for image processing that allows a computer to perform the functions of:
detecting a face area corresponding to a face image in a target image;
generating an organ detecting image including the face image which is inclined in a predetermined angular range in an image plane on the basis of the detection result of the face area; and
detecting an organ area corresponding to a facial organ image in the face area on the basis of image data indicating the organ detecting image.
